(19) United States
(12) Patent Application Publication
(10) Pub. No.: US 2007/0187570 A1
(43) Pub. Date: Aug. 16, 2007

(54) Construction block system

(76) Inventor: Dan Meyer, Ashland, OH (US)

Correspondence Address: MCNEES WALLACE & NURICK LLC, 100 PINE STREET, P.O. BOX 1166, HARRISBURG, PA, 17108-1166, US

(21) Appl. No.: 11/353,758

(22) Filed: Feb. 14, 2006

(51) Int. Cl. A01J 25/13

(52) U.S. Cl. 249/117

(57) ABSTRACT

A construction block fabrication system is provided. This system includes a tool for casting a construction block and a construction block that has been cast in the tool. The tool includes a base having an upper surface and a lower surface; a raised portion formed on the upper surface; at least one elevated platform formed on the raised portion; and a plurality of hinged panels attached to the base, wherein the plurality of hinged panels and the base cooperate to form a reservoir. The construction block includes a body; a recessed surface on one side of the body, wherein the recessed surface corresponds to the raised portion on the base; and at least one receptacle housing mountable within the body.

### BACKGROUND OF THE INVENTION

The described invention relates in general to systems, devices, and methods for creating a block useful for construction purposes, and more specifically to a system for making a construction block that includes one or more housings that are adapted to receive electrical wiring or devices.

The construction of buildings that include concrete and/or masonry block often includes the placement of electrical outlets and/or other electrical devices on the surface of the concrete or masonry block. Surface placement or “surface mounting” of such devices is common because in many cases it may be impractical or perhaps impossible to create a suitable recess or cavity within the existing concrete or masonry block.

Although widely used, the “surface mount” method of installation has significant limitations. For example, locating and installing outlets or other devices (e.g., switches, connectors, jacks) in a surface mount manner can be difficult and time consuming. The outlet or device may also be exposed to a variety of environmental hazards such as moisture and traffic damage, i.e., strikes or impacts. In time, outlets and/or devices installed in this manner can break open, exposing internal parts and creating dangerous shock hazards and other problems. Thus, there is a need for a system and method for placing multiple electrical connections at various locations in, not on, stone, masonry block and concrete surfaces.

### SUMMARY OF THE INVENTION

The following provides a summary of exemplary embodiments of the present invention. This summary is not an extensive overview and is not intended to identify key or critical aspects or elements of the present invention or to delineate its scope.

In accordance with one aspect of the present invention, a construction block fabrication system is provided. This system includes both a tool for casting a construction block and a construction block that has been cast in the tool. The tool itself further includes: (i) a base having an upper surface and a lower surface; (ii) a raised portion formed on the upper surface of the base; (iii) at least one elevated platform formed on the raised portion; and (iv) a plurality of hinged panels attached to the base, wherein the plurality of hinged panels and the base cooperate to form a reservoir. The construction block itself further includes: (i) a body; (ii) a recessed surface on one side of the body, wherein the recessed surface corresponds to the raised portion on the base; and (iii) at least one receptacle housing, wherein the at least one receptacle housing is partially mounted within the body, and wherein the position of the at least one receptacle housing within the body is determined by the position of the at least one platform.

In accordance with another aspect of the present invention, a method for making a construction block is provided. This method includes: (a) providing a tool for casting a construction block, wherein the tool further comprises: (i) a base having an upper surface and a lower surface; (ii) a raised portion formed on the upper surface; (iii) at least one elevated platform formed on the raised portion; and (iv) a plurality of hinged panels attached to the base, wherein the plurality of hinged panels and the base cooperate to form a reservoir; and (b) placing a receptacle housing within the reservoir on each of the at least one elevated platforms; (c) pouring a liquefied casting material into the reservoir; (d) allowing the casting material to solidify; (e) releasing the hinged panels to expose the solidified casting material; and (f) removing the solidified casting material from the tool, wherein the solidified casting material further comprises a recessed surface that corresponds to the raised portion on the base of the tool.

In yet another aspect of this invention, a construction device is provided. This device includes: (i) a body; (ii) a recessed surface portion formed on one side of the body; and (iii) at least one receptacle housing, wherein the at least one receptacle housing is partially or wholly mounted within the body, and wherein an open portion of the at least one receptacle housing is mounted within the recessed surface portion.

Additional features and aspects of the present invention will become apparent to those of ordinary skill in the art upon reading and understanding the following detailed description of the exemplary embodiments. As will be appreciated, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a front view of an exemplary embodiment of the construction block of the present invention.

FIG. 2 is a rear view of an exemplary embodiment of the construction block of the present invention.

FIG. 3 is a side perspective view of an exemplary embodiment of the tool component of the system of the present invention.

FIG. 4 is a top view of an exemplary embodiment of the tool component of the system of the present invention.

### DETAILED DESCRIPTION OF THE INVENTION

Exemplary embodiments of the present invention are now described with reference to the Figures. Reference numerals are used throughout the detailed description to refer to the various elements and structures. In other instances, well-known structures and devices are shown in block diagram form for purposes of simplifying the description. Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention. Certain terminology is used in the following description for convenience only and is not limiting. The word “block,” as used in the claims and in the corresponding portions of the specification, means “any one of a brick, a concrete block, a masonry block, a masonry unit, a block, and a stone of varying shape and size.” The term “receptacle housing”, as used in the claims and in corresponding portions of the specification, means any electrical housing, box, or device that can be used to contain electrical wiring, components, plugs, switches, jacks, connectors, or other electrical devices and/or components. The terminology includes the words noted above, derivatives thereof, and words of similar import.

The present invention relates to a system, device, and method for creating a block useful for construction purposes. A first general embodiment of this invention provides a construction block system, which includes a tool for casting a construction block and a construction block that has been cast in the tool. The tool further includes: (i) a base having an upper surface and a lower surface; (ii) a raised portion formed on the upper surface; (iii) at least one elevated platform formed on the raised portion; and (iv) a plurality of hinged panels attached to the base, wherein the plurality of hinged panels and the base cooperate to form a reservoir. The construction block further includes: (i) a body; (ii) a recessed surface on one side of the body, wherein the recessed surface corresponds to the raised portion on the base; and (iii) at least one receptacle housing, wherein the at least one receptacle housing is partially mounted within the body, and wherein the position of the at least one receptacle housing within the body is determined by the position of the at least one platform. A second general embodiment of this invention provides a method for making a construction block, which includes the steps of (a) providing the previously described tool for casting a construction block; (b) placing a receptacle housing within the reservoir on each of the at least one elevated platforms; (c) pouring a liquefied casting material into the reservoir; (d) allowing the casting material to solidify; (e) releasing the hinged panels to expose the solidified casting material; and (f) removing the solidified casting material from the tool, wherein the solidified casting material further comprises a recessed surface that corresponds to the raised portion on the base of the tool. A third general embodiment of this invention provides a construction device, which includes: (i) a body; (ii) a recessed surface portion formed on one side of the body; and (iii) at least one receptacle housing, wherein the at least one receptacle housing is partially or wholly mounted within the body, and wherein an open portion of the at least one receptacle housing is mounted within the recessed surface portion.

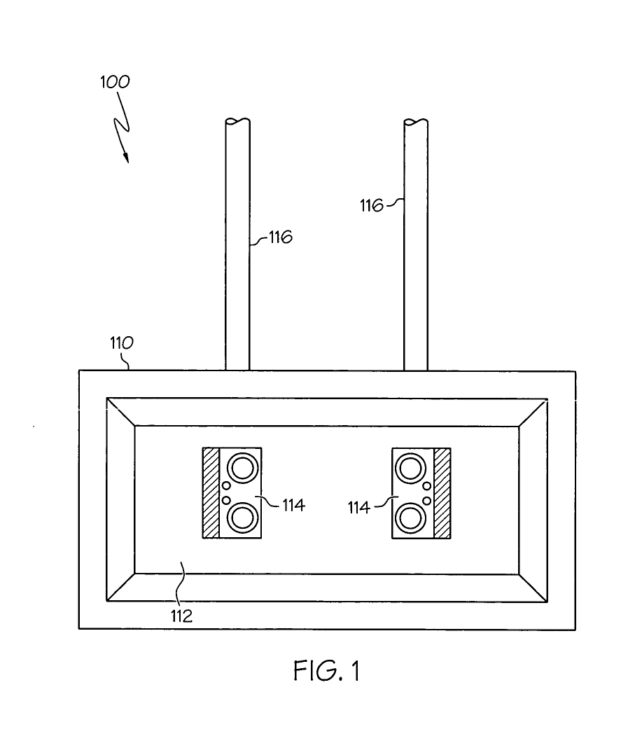

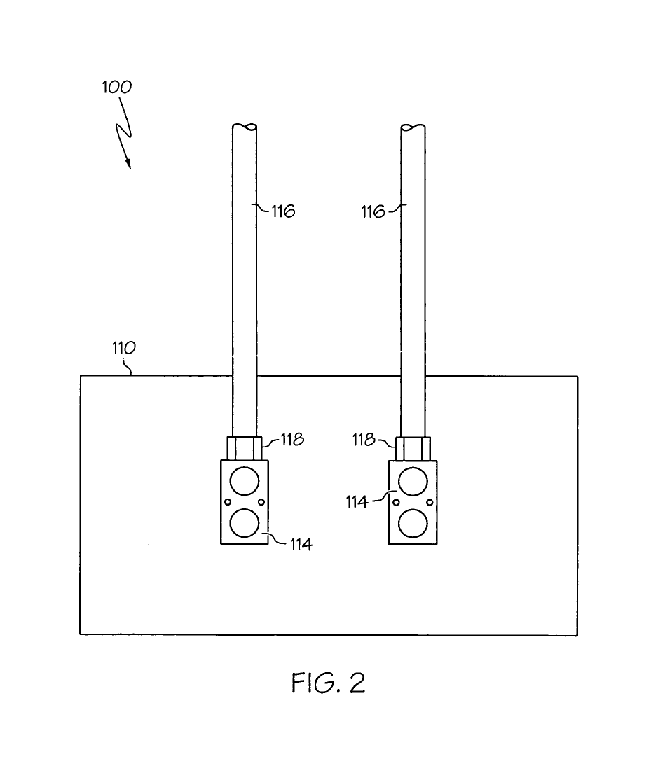

With reference now to the Figures, FIG. 1 provides a front view of an exemplary embodiment of the construction block of the present invention and FIG. 2 provides a rear view of an exemplary embodiment of the construction block of the present invention. A shown in FIG. 1, construction block 100 includes a generally rectangular body 110 that includes a recessed portion or surface 112. In this embodiment, two receptacle housings 114 are partially mounted within construction block 100 and an open portion of each receptacle housing 114 is mounted in and is accessible from recessed area 112. Recessed surface 112 moves any electrical equipment or devices that may be housed within receptacle housings 114 back and away from the surface of the wall or other structure or area within which construction block 100 will ultimately be placed or mounted. Recessing electrical equipment or devices in this manner provides a measure of protection, i.e., shelter, for these items. As shown in FIG. 2, a rear, closed portion of each receptacle housing may remain outside of the material from which body 110 is made for ease of access to the interior of the housing. In this embodiment, a length of tubing or conduit 116 has been attached to each receptacle housing 114 at each collar 118. Electrical wiring may be run to or from receptacle housing 114 through conduit 116.

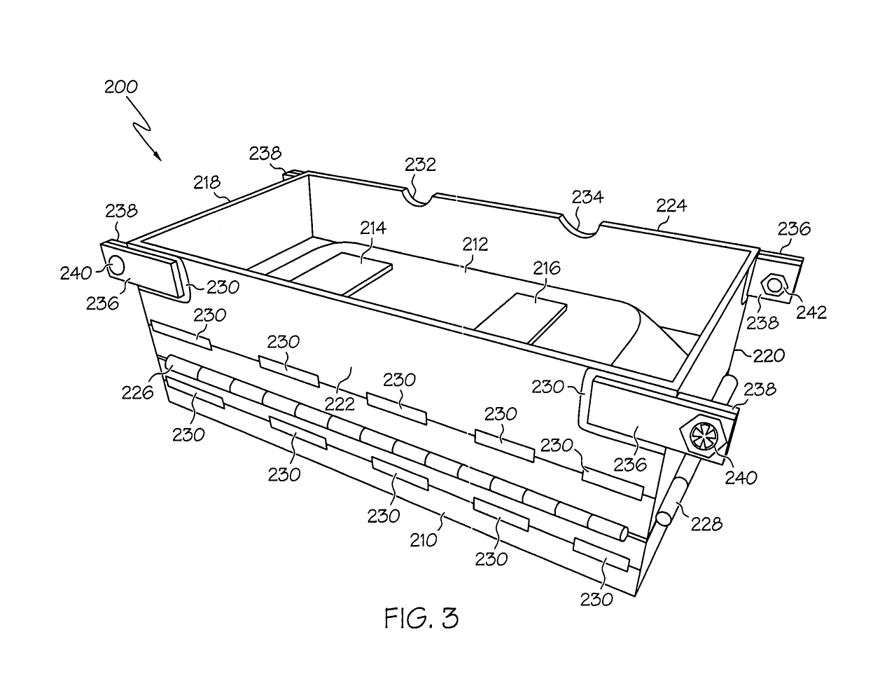

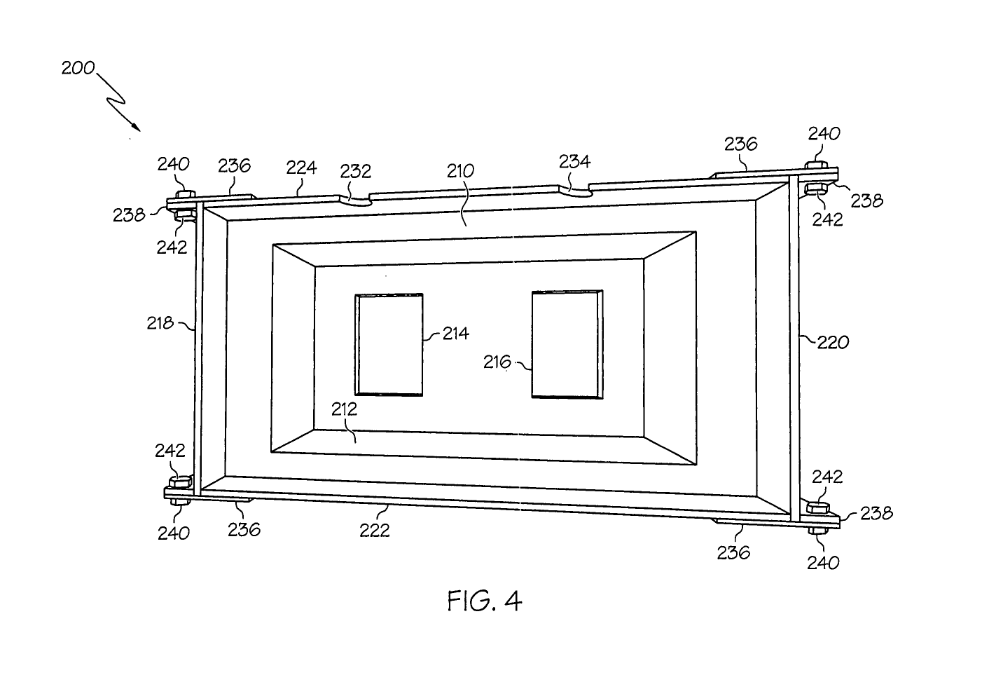

FIG. 3 provides a side perspective view of an exemplary embodiment of the mold or tool component of the system of the present invention and FIG. 4 provides a top view of an exemplary embodiment of the tool component of the system of the present invention. As shown in FIGS. 3-4, tool 200 includes a generally rectangular base 210 that further includes a centrally placed raised portion 212. Raised portion 212 includes a first elevated platform 214 and a second elevated platform 216. In some embodiments, only a single elevated platform is included. A series of moveable panels are attached to base 210 by hinges or other means. In the exemplary embodiment shown in the Figures, a first end panel 218 and a second end panel 220 are each attached to one of the end portions of base 210 by an end panel hinge 228. Likewise, a first side panel 222 and a second side panel 224 are each attached to one of the side portions of base 210 by a side panel hinge 226. Second side panel 224 includes a first cutout region 232 and a second cutout region 234, the placement of which corresponds generally to the placement of the first and second elevated platforms 214 and 216. When in a closed position, the end and side panels 218, 220 and 222, 224 cooperate with the base 210 to form a reservoir. The end and side panels are secured to one another by a series of connectors. Each side panel includes two side panel connectors 236, and each end panel includes two end panel connectors 238. A series of bolts 240 and nuts 242 are used to connect the side panel connectors 236 to the end panel connectors 238. In this embodiment, the hinges are spot welded to the base and the end and side panels at a plurality of weld joints 230. Likewise, the side and end panel connectors are spot welded to their respective side or end panels at weld joints 230. In other embodiments of tool 200, the hinges and side and end panel connectors are formed integrally with or are attached to the side and/or end panels of tool 200 by other attachments means, such as, for example screws, rivets, bolts, or any other acceptable attachments means. As will be appreciated by the skilled artisan, the various components of tool 200 are typically steel, iron, or any other material or combinations of materials suitable for casting concrete or similar construction materials.

The exemplary embodiment of tool 200 shown in FIGS. 3-4 may be used to create the exemplary embodiment of construction block 100 shown in FIGS. 1-2 according to the following exemplary method. A receptacle housing 114, to which a length of conduit 116 has been attached, is placed on each of the elevated platforms 214 and 216. The slight elevation of platforms 214 and 216 provides stability to the receptacle housings within the reservoir during the casting process. When properly placed within the reservoir, a portion of each length of conduit 116 will rest in either first or second cutout region 232, 234. A liquefied casting material, such as concrete, is then poured into the reservoir around the receptacle housings 114 and allowed to solidify or cure, i.e., harden, for a predetermined period of time. Bolts 240 and nuts 242 are removed from side and end panel connectors 236 and 238, and the hinged side and end panels 218, 220 and 222, 224 are released, i.e., moved from an upward or closed position to a more downward or open position. The solidified or cured casting material is then removed from tool 200 and construction block 100 is ready for use. After removal of the solidified block, the tool 200 may be “reset” by returning the end and side panels to the closed position and returning bolts 240 and nuts 242 to their starting positions.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept. For example, the general shape of the base and the resulting block may be rectangular, square, trapezoidal, or any of a variety of geometric shapes and configurations. Additionally, in some embodiments of this invention, raised portion 212 is absent from tool 200 therefore, the construction block that is made using this embodiment of tool 200 includes a face that is substantially flush with the surface that construction block 100 is being mounted within. Thus, in some embodiments of construction block 100, recessed surface 112 is absent. Also, in some embodiments of the method for making construction block 100, the receptacle housing is replaced by a casting mold that is removed from the construction block once the concrete or other material has solidified or cured, thereby creating a cavity within body 110. Thus, receptacle housings or other devices may be added to construction block 100 after it has been cast and may be mounted within the cavity created in body 110.

1) A construction block system, comprising:
(a) a tool for casting a construction block, wherein the tool further comprises:
(i) a base having an upper surface and a lower surface;
(ii) a raised portion formed on the upper surface;
(iii) at least one elevated platform formed on the raised portion; and
(iv) a plurality of hinged panels attached to the base, wherein the plurality of hinged panels and the base cooperate to form a reservoir; and
(b) a construction block, wherein the construction block is cast in the tool and further comprises:
(i) a body;
(ii) a recessed surface on one side of the body, wherein the recessed surface corresponds to the raised portion on the base; and
(iii) at least one receptacle housing, wherein the at least one receptacle housing is mountable within the body, and wherein the position of the at least one receptacle housing within the body is determined by the position of the at least one platform.

2) The system of claim 1, further comprising a plurality of connectors attached to or formed integrally with the plurality of hinged panels for connecting the hinged panels to one another to form the reservoir.

3) The system of claim 1, wherein at least one of the hinged panels further comprises at least one cutaway region adapted to receive conduit attachable to the at least one receptacle housing.

4) The system of claim 1, wherein the at least one receptacle housing further comprises a length of conduit attached thereto.

5) The system of claim 1, wherein the shape of the construction block is substantially rectangular, square, or trapezoidal.

6) A method for making a construction block, comprising:
(a) providing a tool for casting a construction block, wherein the tool further comprises:
(i) a base having an upper surface and a lower surface;
(ii) a raised portion formed on the upper surface;
(iii) at least one elevated platform formed on the raised portion; and
(iv) a plurality of hinged panels attached to the base, wherein the plurality of hinged panels and the base cooperate to form a reservoir; and
(b) placing a receptacle housing within the reservoir on each of the at least one elevated platforms;
(c) pouring a liquefied casting material into the reservoir;
(d) allowing the casting material to harden;
(e) releasing the hinged panels to expose the solidified casting material; and
(f) removing the hardened casting material from the tool, wherein the hardened casting material further comprises a recessed surface that corresponds to the raised portion on the base of the tool.

7) The method of claim 6, further comprising the step of removing the receptacle housing from the reservoir after the casting material has substantially hardened and before removing the hardened casting material from the tool.

8) The method of claim 6, wherein the tool further comprises a plurality of connectors attached to or formed integrally with the plurality of hinged panels for connecting the hinged panels to one another.

9) The method of claim 6, wherein at least one of the hinged panels further comprises at least one cutaway region adapted to receive conduit attachable to the at least one receptacle housing.

10) The method of claim 6, wherein the at least one receptacle housing further comprises a length of conduit attached thereto.

11) The method of claim 6, wherein the casting material further comprises concrete.

12) The system of claim 6, wherein the shape of the construction block is substantially rectangular, square, or trapezoidal.

13) A construction device, comprising:
(i) a body;
(ii) a recessed surface portion formed on one side of the body; and
(iii) at least one receptacle housing, wherein the at least one receptacle housing is partially or wholly mountable within the body, and wherein an open portion of the at least one receptacle housing is mountable within the recessed surface portion.

14) The device of claim 12, wherein the at least one receptacle housing further comprises a length of conduit attached thereto.

15) The device of claim 12, wherein the body further comprises concrete.

16) The device of claim 12, wherein the shape of the device is substantially rectangular, square, or trapezoidal.
